(19) United States
(12) Patent Application Publication
(10) Pub. No.: US 2025/0182409 A1
(43) Pub. Date: Jun. 5, 2025

(54) SYSTEMS AND METHODS FOR DELIVERING SCALABLE SUPPLEMENTAL CONTENT IN EXTENDED REALITY

(71) Applicant: Adeia Guides Inc., San Jose, CA (US)

(72) Inventor: Warren Keith Edwards, Atlanta, GA (US)

(21) Appl. No.: 18/527,944

(22) Filed: Dec. 4, 2023

(51) Int. Cl. G06T 19/00; G06F 3/01; H04L 67/306

(52) U.S. Cl. CPC G06T 19/006; G06F 3/011; H04L 67/306

(57) ABSTRACT

The present application provides for delivering scalable supplemental content in augmented reality by implementing an exchange server that filters detectors that an AR device applies and thus reduces the amount of computational load at the AR device. The exchange server may receive user profile/AR device data and also receive detector requests from AR insertion requesters. The exchange server may select at least one detector based on matching the user profile/AR device data to the detector requests. Once these matching detector requests are selected, the exchange server may transmit instructions to the AR device to execute these detector requests to detect a matching object. Upon a matching object being detected, the exchange server accesses and selects AR supplemental content based on matching object metadata and then transmits an instruction to the AR device to display the selected supplemental content to appear overlaid over the physical environment proximate to the matching object.

### BACKGROUND

This disclosure is related to systems and methods for user interfaces in extended reality mediums.

### SUMMARY

The potential of extended reality, and particularly augmented reality (AR), for supplemental content delivery has long been recognized. AR supplemental content is a way for content producers to create more immersive experiences, and associate a richer engagement with real-world objects and locations in ways that are difficult for current web- and mobile-based supplemental content. In many of these examples, content producers can provide additional engagement with real-world objects that are seen through a viewfinder of an AR device. For example, a monument in a city may be seen, and the tourism board of the city may wish to provide supplemental content as to the history of the monument. This may be done by overlaying AR supplemental content and/or a related user-interface prompt at a virtual anchor over the monument.

While such implementations are compelling for content producers, they may be difficult to accomplish in a practical way. Sheer scale is an inhibitor, for example: just as there are content producers in the web-based world, there may be similar content producers who wish to place AR supplemental content, each of which may require spotting a specific object in a scene on a user's device. There is immense processing bandwidth required to perform the required object recognition to place anchored supplemental content on the AR device. The more requests for objection recognition for AR insertion are received, the worse the problem of scale for providing AR supplemental content gets.

In one approach, a central server gathers all visual data of the physical environment of all AR devices in an area to detect an inordinate amount of objects and then subsequently determines which AR supplemental content would be relevant for all the detected objects. This is an exorbitant amount of computational load upon the central server. Moreover, there could be compounding issues of bandwidth to receive environmental data from the AR device and transmit the AR data to the AR device. In another approach, a local AR device gathers all visual data of the physical environment to detect an inordinate amount of objects and then subsequently determines which AR supplemental content would be relevant for all the detected objects. In similar regard, this is an exorbitant amount of computational load upon the AR device which is often already limited in computation due to their mobile nature.

To help overcome these problems, systems and methods are provided herein for delivering scalable supplemental content in augmented reality by implementing an exchange server that filters detectors, which an AR device applies, and thus reduces the amount of computational load for object detection for the AR device. An exchange application may be installed on the exchange server to implement the steps for scaling AR supplemental content. In some embodiments, the exchange server may receive user profile data/device data from the AR device, and receive detector requests from AR insertion requesters (e.g., city tourism servers). The exchange server may select at least one detector based on matching the user profile/device data to the detector requests. Once these matching detector requests are selected, the exchange server transmits instructions to the AR device to execute this subset of selected detector requests to detect a matching object (e.g., a tram within a city view). The AR device may run an AR application to implement the instructions sent from the exchange server. Upon a matching object being detected, the exchange server accesses and selects AR supplemental content based on matching object metadata and then transmits an instruction to the AR device to display the selected supplemental content to appear overlaid over the physical environment proximate to the matching object. In some approaches, supplemental content offers are solicited live (e.g., analyzed on a frame-by-frame basis) with the AR insertion requesters providing a plurality of detectors on demand subsequent to detecting objects; and in some approaches, supplemental content offers are preloaded with the AR insertion requesters sending AR requests prior to the detection of objects.

For example, the exchange server would cause a user device to place a text bubble proximate to the tram providing a prompt to learn more about the tram system in the city. In some embodiments, when accessing the AR supplemental content, the exchange server transmits a detection notification to the AR insertion requesters, and consequently then receives requests for AR insertion of AR supplemental content from the AR insertion requesters.

Accordingly, the present disclosure provides for an improved delivery of scalable supplemental content in AR by implementing an exchange server. The system retrieves computational information for all devices within the system including the AR device, AR insertion requester, and the exchange server. Based on the computational capacity of each of these devices, the exchange server provides for a calculated limited set of detectors to not overburden the computation of these devices in the system to ensure a quality of service irrespective of computing capacity.

Instead of detecting every object available in an AR environment, the exchange server only sends a calculated set of instructions to detect a subset of objects that are of interest to the user of the AR device. The overall computational load at the AR device is reduced by preprocessing and reducing the number of objects to detect at the AR device.

Additionally, the exchange server, by not detecting every object in every environment, may be configured to only detect a subset of objects based on privacy-based rules to respect various environmental privacy regulations or preferences of end-users. In this configuration, the same computational efficiency benefit is realized by reducing the number of objects to compute based on filtering the aggregate number of detectors to only detect a subset of objects within an environment.

In some embodiments, the exchange server determines the presence of a common object by determining whether detection of the object at a corresponding location exceeds a frequency threshold. If so, the exchange server saves the location data for the matching common object. In the future, when the AR device is at that location, the exchange server can automatically select and transmit the AR supplemental content to appear overlaid within the physical environment proximate to the common object. For example, if an AR device is routinely used within a household, and the fridge object is detected at the same location in excess of 10 times (e.g., frequency threshold), the exchange server will save the fridge object's corresponding locational information. The next time the AR device is proximate to the location, the exchange server will automatically transmit supplemental content overlaid on the fridge. By building a library of common objects, the exchange server reduces computational load instead of running a detector for all the objects within a common location having static locations for a number of objects.

In some embodiments, when the exchange server matches the object in the physical environment, it may implement a machine learning model. This may include receiving training data with confirmed data of the matching object (e.g., confirmed pictures of a fridge), and the exchange server may train the machine learning model based on the training data and then detecting capture of the physical environment into the model (e.g., objects in the kitchen including the fridge). In some embodiments, when selecting a detector based on matching the user profile/AR device data to the detector requests, the exchange server may determine whether the number of AR insertion requesters requesting the particular detector exceeds a popularity threshold. For example, if a large group of AR insertion requesters are requesting a tram detector, then the tram detector is popular. This is one manner in which the exchange server selects a detector.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative scenario in which an exchange server delivers scalable supplemental content in augmented reality, in accordance with some embodiments of this disclosure.

FIG. 2 shows another illustrative scenario in which an exchange server delivers scalable supplemental content in augmented reality, in accordance with some embodiments of this disclosure.

FIG. 3 shows an illustrative scenario of an AR device matching an object in a physical environment, in accordance with some embodiments of this disclosure.

FIG. 4 shows an illustrative scenario of an AR device matching an object in a physical environment where the object comes in and out of view, in accordance with some embodiments of this disclosure.

FIG. 5 shows an illustrative scenario of an exchange server saving frequently viewed objects, in accordance with some embodiments of this disclosure.

FIG. 6 shows an exemplary machine learning model being trained with training data, in accordance with some embodiments of this disclosure.

FIG. 7 shows a flowchart of an AR device, AR provider service, exchange server, AR insertion device, and AR insertion requester, in accordance with some embodiments of this disclosure.

FIG. 8 shows illustrative user equipment devices, in accordance with some embodiments of this disclosure.

FIG. 9 shows illustrative systems, in accordance with some embodiments of this disclosure.

FIG. 10 is a flowchart of a detailed illustrative process for transmitting an instruction to display the selected supplemental content to appear overlaid over the physical environment proximate to the matching object, in accordance with some embodiments of this disclosure.

FIG. 11 is a flowchart of another detailed illustrative process for determining whether the indication of detection of the matching object at a corresponding location exceeds a frequency threshold, in accordance with some embodiments of this disclosure.

### DETAILED DESCRIPTION

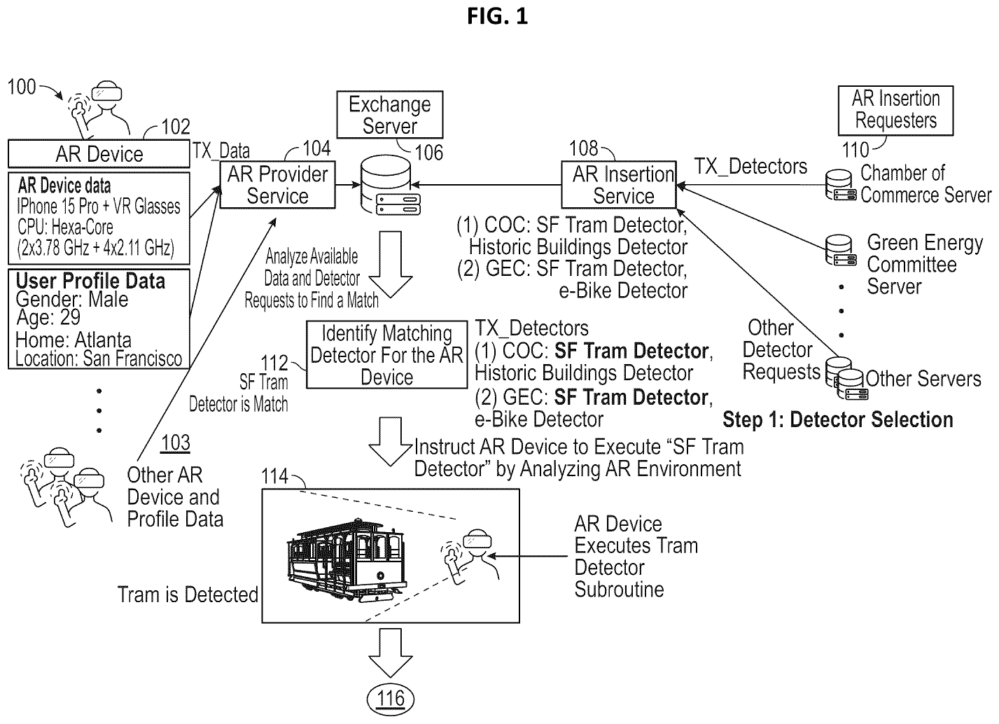

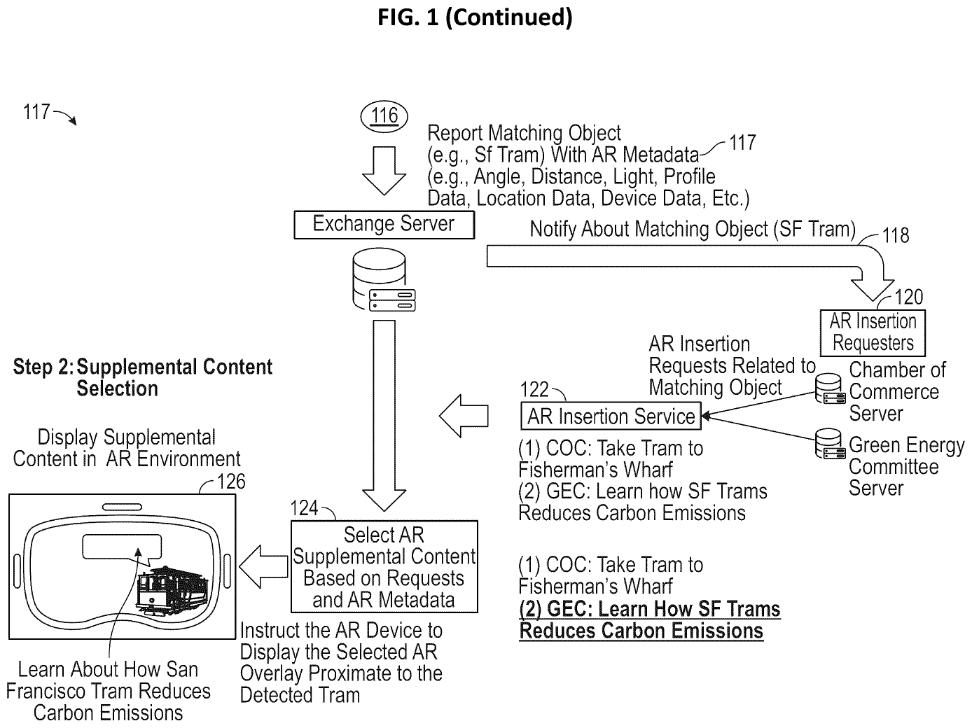

FIG. 1 shows an illustrative scenario 100 in which an exchange server delivers scalable supplemental content in augmented reality, in accordance with some embodiments of this disclosure. In some embodiments, the exchange server may deliver scalable supplemental content in extended reality environments including virtual reality. An exchange server 106 may be any user equipment which has control circuitry for processing and communication circuitry to interface with other devices such as AR device 102. In some embodiments, the exchange server receives, from an AR device, user profile data and AR device data. AR device data may include hardware specification, software installed and prospective compatibility. AR device data may further include processing capacity, LIDAR, biometric information, optical device capacity, or networking capacity. For example, AR device data as shown in FIG. 1 includes the following data: iPhone 15 Pro, VR Glasses, CPU: Hexa-core (2×3.78 GHz+4×2.11 GHz). In some embodiments, the type of processing is important device data as it allows the exchange server to determine how much computing load should be allocated to the AR device versus kept at the exchange server. Moreover, the exchange server will know what level of technology the AR device has AR capabilities for provision of the AR supplemental content. User profile data may include biographical, locational, biometric, or habitual data about the user using the AR device. This user profile data may be inherent to the software of the AR device and/or included in one or more software installed on the AR device. In some embodiments, the user profile data may include internet browser history, online purchasing history, and/or similar types of data. For example, user profile data as shown in FIG. 1 includes the following data: Gender: Male, Age: 29, Home: Atlanta, and Location: San Francisco. For example, the exchange server may receive the user profile data from a social networking application installed on the AR device. In some embodiments, the user profile data and the AR device data may be received via an AR provider service. For example, the social networking application may have its own server which may be an AR provider service 104. In this example, the AR device transmits data from the AR device to the AR provider service 104, and the AR provider service transmits the data to the exchange server. In some embodiments, the AR provider service is embedded in hardware on the AR device, while in some embodiments, the AR provider service is a stand-alone cloud server. In some embodiments, the exchange server receives multiple AR device data and user data from a plurality of AR devices 103.

The exchange server may receive, from a plurality of AR insertion requesters 110, a plurality of requests for running a plurality of detectors. An insertion requester may be a server for a third party which wishes to share information presented as AR supplemental information to appear overlaid over the real-world physical environment proximate to a matching object. An insertion requester may be a city tourism board server wishing to promote landmarks in the city, or a government authority to promote public service announcements (e.g., regulation relation, health related, etc.), or a business promoting goods or services (e.g., new product placement). For example, AR insertion requesters in FIG. 1 include the Chamber of Commerce server, the Green Energy Committee server, and other servers. Each of these AR insertion requesters are configured to execute a number of detectors. Detectors are a set of software-based constraints to detect one or more objects (e.g., a tram in a city, a mailbox, wave-height in the ocean, etc.). In some embodiments, the AR insertion requesters transmit the plurality of requests for running a plurality of detectors to an AR insertion service 108. Each of the AR insertion requesters may be its own AR insertion service. In other embodiments, the AR insertion requesters send the detector information to the AR insertion service as an intermediary. In some embodiments, the AR insertion service is embedded in hardware on the AR device, while in some embodiments, the AR insertion service is a stand-alone cloud server. For example, an AR insertion service may be a governmental city based AR insertion service that receives the plurality of requests for running a plurality of detectors from one or more AR insertion requesters that are city related, such as health authority and tourism board. In FIG. 1, the AR insertion service receives two detectors from the Chamber of Commerce namely a San Francisco tram detector and a historic building detector. Additionally, the AR insertion service receives two detectors from the Green Energy Committee namely a San Francisco tram detector and an e-bike detector.

The exchange server may select at least one detector based on matching the user profile data and the AR device data to the plurality of requests. The selection may be based on a varied set of programmatic or logic rules. For example, the exchange server may determine, for a particular detector, the number of AR insertion requesters requesting the particular detector. For example, both the Chamber of Commerce and the Green Energy Committee AR insertion requesters are requesting a San Francisco tram detector. The exchange server may, in response to the number of AR insertion requesters exceeding a popularity threshold, select that particular detector. In this example, if the popularity threshold has a value of 2 or greater, then the San Francisco tram detector will be selected. The popularity threshold may be preconfigured to a desired value, or it may be automatically generated based on a mathematical model formed from aggregate data to achieve a more dynamic value. In some embodiments, the exchange server may implement a machine learning model to determine which detectors should be selected with various ideal constraints provided by the exchange server. In some embodiments, the detectors are given priority for selection based on the type of AR insertion requesters providing the detector. For example, if the AR insertion requester is governmental, it may be given a higher priority for selection than a non-governmental AR insertion requester. In FIG. 1, because the user profile data specifies that the locational information of the AR device is present in San Francisco, this gives higher priority to detectors that are local to San Francisco (e.g., the San Fransisco tram detector). The exchange server may provide even higher priority as the home location of the user is Atlanta which provides a qualified assumption that the user is visiting San Francisco and may be interested in tourism information. Moreover, the user information may be used to match with pre-generated filters provided by the AR insertion service which may provide rules for certain detectors to be only applied for specific user information. For example, the AR insertion service may provide rules stating the San Franscico tram detector may only be applied to male or female within ages 10 to 55. In some embodiments, the exchange server may select at least one detector based on the AR insertion request rules and the user profile data and AR device data. In FIG. 1, the exchange server selects the San Franscico tram detector 112 based on the user profile data (e.g., visiting San Francisco and age 29) and the AR device data (e.g., has AR device having sufficient bandwidth, processing power, and software capabilities (e.g., an ARCore-enabled device) to display the AR supplemental data from the AR insertion requester).

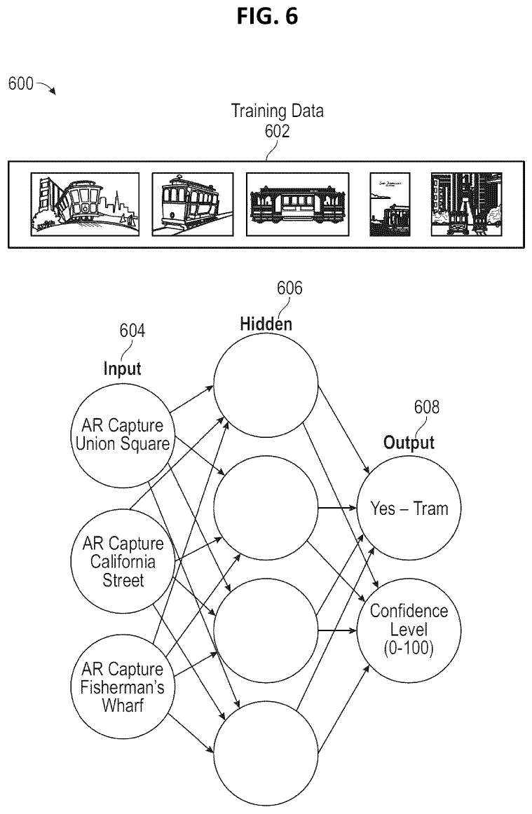

The exchange server may transmit instructions to the AR device that cause the AR device to execute the at least one detector to detect a matching object in a physical environment visible via the AR device. In some embodiments, the exchange server may implement a machine learning algorithm to detect a matching object in the physical environment. FIG. 6 shows an exemplary machine learning model 600 being trained with training data, in accordance with some embodiments of this disclosure. The exchange server may receive training data with confirmed data of the matching object. In FIG. 6, the confirmed data of a San Francisco tram is shown 602. The exchange server may train a machine learning model based on the received training data. The exchange server may then implement detecting inputting capture of the physical environment into the trained model at 604. For example, an AR capture from California street in San Francisco will be input into the model that becomes analyzed by the hidden nodes executing various mathematical models to determine matching probability and outputs, at 608, a Boolean output of “Yes-Tram” or “No-Tram” along with a confidence value from 0-100. In FIG. 1, the exchange server instructs the AR Device to execute the San Francisco tram detector subroutine while the AR device (e.g., AR glasses) is capturing the physical environment of San Francisco. At 114, the AR device detects a San Francisco tram within the view of the AR device.

The exchange server may receive, from the AR device, an indication of detection of the matching object and matching object metadata. Object metadata may include, but is not limited to, environmental data related to the object such as the object's angle, distance, light, profile data, location data, obstruction level, device data relative to the AR device. In some embodiments, the exchange server transmits a detection notification to the plurality of AR insertion requesters. The exchange server receives a plurality of requests for AR insertion of AR supplemental content from the plurality of AR insertion requesters. In FIG. 1, the exchange server reports, at 117, the matching object (e.g., SF tram) with AR metadata (e.g., 1200 lumens, angle of 60 degrees, no shadow, 33.5 feet distance).

The exchange server may access a plurality of requests for AR insertion of AR supplemental content that were received from the plurality of AR insertion requesters. The exchange server then selects a selected AR supplemental content based on the plurality of requests for AR insertion of AR supplemental content and the matching object metadata. In some embodiments, the AR supplemental content requires specific AR metadata to be true for application. For example, an AR supplemental content may only be applicable if lighting is greater than 1000 lumens. In some embodiments, the exchange server selects the selected AR supplemental content based on priority of the AR insertion requester, or the priority of the specific AR supplemental content. In some embodiments, the AR insertion requester may indicate higher priority for the AR supplemental content. In some embodiments, the AR insertion requester may provide consideration (e.g., monetary units) to the exchange server for higher priority for the AR supplemental content. In this embodiment, the exchange server would select the selected AR supplemental content based on the consideration provided. In some embodiments, the AR insertion requester may implement a condition where the location of the placement of the AR supplemental content matches a predefined list of approved locations. In some embodiments, the AR insertion requester may implement a condition where the AR device must have specific hardware capability such as 120 Hz screen and LIDAR to present the AR supplemental content in the optimal fashion. In some embodiments, the AR insertion requester may implement a condition where the AR device must have specific software capability such as installation of a specific operating system (e.g., Android), or having a specific application installed (e.g., AR sandbox application). In FIG. 1, the exchange server notifies, at 118, the AR insertion requesters about the matching San Francisco tram object. In some embodiments, receiving the plurality of requests for AR insertion of AR supplemental content from the plurality of AR insertion requesters includes receiving the plurality of requests for AR insertion via an AR insertion service. For example, the exchange server receives two AR supplemental content requests from the AR insertion service, at 122, namely: Chamber of Commerce-take tram to Fisherman's wharf, and Green Energy Committee-learn how San Francisco trams reduce carbon emissions. The exchange server selects the Green Energy Committee AR supplemental content at 124. In some embodiments, the indication of detection of the matching object and matching object metadata includes an activity of a user of the AR device based on at least one of movement pattern or biometric data. For example, the biometric data may show an increased heart rate and locational data showing that the AR device is moving and jolting following the movement pattern of the user running. This exchange server may use this biometric data as a supplement to select the selected AR supplemental content.

In some embodiments, the conditions may be classified as static conditions and dynamic conditions. For example, the type of AR device hardware may be static conditions as it tends to change infrequently. In contrast, the lighting conditions for a specific location may be dynamic as the outdoor environment is subject to change continuously. Based on these classifications, the exchange server may save the static conditions for ease of computation when the exchange server is accessing a plurality of requests for AR insertion of AR supplemental content that were received from the plurality of AR insertion requesters and implementing various conditions imposed by the AR insertion requesters. In some embodiments, the static conditions may be configured to be checked by the exchange server at a pre-defined interval (e.g., once a month, or some other pre-programmed time interval). By having the classification of static conditions and dynamic conditions, the exchange server may implement a two-stage filtering where the static filtering has been performed previously, and the processing can move on to the second stage of dynamic filtering. In some embodiments, the static filtering is advantageous to manage privacy concerns as a user may consent to the initial collection of information regarding their home premises and the device need not continuously monitor and detect objects depending on user preferences.

In some embodiments, the exchange server may receive advertisement requests from the AR insertion requester functioning as an advertisement requester. In this scenario, the exchange server accesses a plurality of advertisement requests for AR insertion of AR supplemental content (e.g., advertisements) that were received from the plurality of AR insertion requesters. The exchange server then selects a selected advertisement based on the plurality of requests for AR insertion of advertisements and the matching object metadata. For example, the AR requester may be a product company selling shoes and provide conditions for AR insertion based on the matching object metadata. Namely, the AR requester may specify that a matching shoe object only having lighting of 1200 lumens, in an unobstructed line of sight from the AR device is sufficient to provide the AR supplemental content. In this way, the exchange server can manage the conditions specified by the AR requester which may be implemented to ensure a quality of presentation prior to the display of the advertisement to appear overlaid over the physical environment proximate to the shoes. In some embodiments, the exchange server selects the selected AR supplemental content (e.g., advertisements) based on which of the AR insertion requesters provided the highest monetary value for the AR supplemental content. In this manner, the exchange server functions as an advertisement auction. This is done in real-time much like a header-auction in traditional web-based advertisement. In some embodiments, once the exchange server implements the plurality of conditions from the AR insertion requesters, a selection occurs of which selected AR supplemental content is selected (based on the plurality of requests for AR insertion of AR supplemental content and the matching object metadata).

The exchange server may transmit an instruction, for the AR device, to display the selected AR supplemental content to appear overlaid over the physical environment proximate to the matching object. The exact position may be anchors proximate to the matched object. In some embodiments, the anchors may be preconfigured by the AR insertion requester. In some embodiments, the anchors may be preconfigured by the exchange server and the anchor is sent as an instruction to the AR device for placement. In some embodiments, the exchange server may determine the anchor for the exact placement of the AR supplemental content in real-time based on the object meta-data (e.g., lighting, angle, etc.). In FIG. 1, the exchange server instructs the AR Device to display the selected AR overlay, at 126, proximate to the detected San Fransico tram, with the overlay being a text bubble reciting “Learn about how San Francisco tram reduces carbon emissions.” In some embodiments, the exchange server instructs the AR device to display an advertisement (i.e., the AR supplemental content) to appear overlaid over the physical environment proximate to the matching object. For example, an advertisement may be placed over a person wearing a pair of shoes where the advertisement displays the brand, model, price, and code to purchase the shoes.

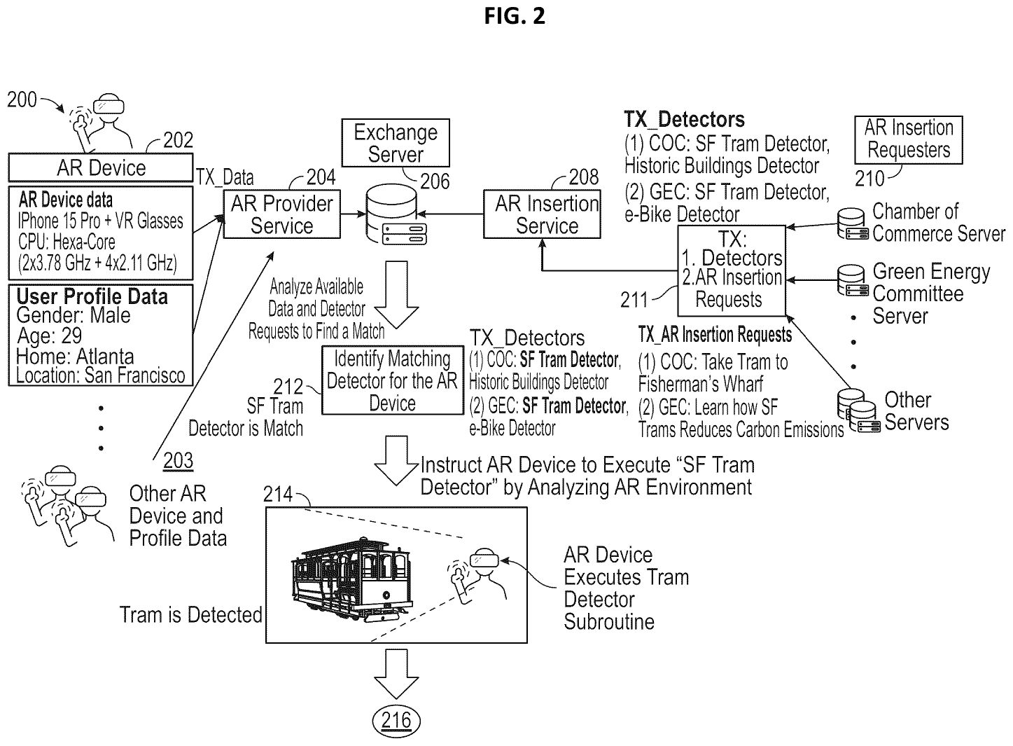

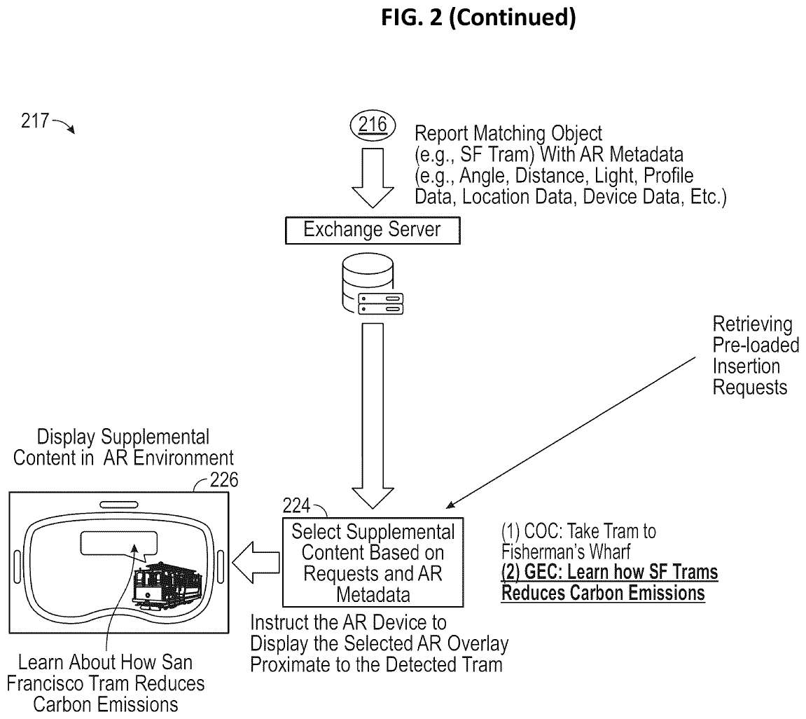

FIG. 2 shows another illustrative scenario 200 in which an exchange server delivers scalable supplemental content in augmented reality, in accordance with some embodiments of this disclosure. In FIG. 1, the exchange server transmits a detection notification to the plurality of AR insertion requesters, and subsequently the exchange server then receives a plurality of requests for AR insertion of AR supplemental content from the plurality of AR insertion requesters. In FIG. 2, the exchange server 206 receives a plurality of requests for running a plurality of detectors from a plurality of AR insertion requesters. The exchange server also simultaneously accesses a plurality of requests for AR insertion that were received from the plurality of AR insertion requesters. The exchange server receives user profile data and AR device data from AR device at 202, via the AR provide service at 204. In some embodiments, the exchange server receives multiple AR device data and user data from a plurality of AR devices 203.

The exchange server may receive, from a plurality of AR insertion requesters 210, a plurality of requests for running a plurality of detectors. At 211, the exchange server also simultaneously accesses a plurality of requests for AR insertion of AR supplemental content that were received from the plurality of AR insertion requesters. The exchange server may receive this data via the AR insertion service 208. The exchange server may select at least one detector based on matching the user profile data and the AR device data to the plurality of requests at 212.

The exchange server may transmit instructions to the AR device that cause the AR device to execute the at least one detector to detect a matching object in a physical environment visible via the AR device at 214. The exchange server may then access the plurality of requests for AR insertion of AR supplemental content that were received from the plurality of AR insertion requesters (initially), and selects a selected AR supplemental content based on the plurality of requests for AR insertion of AR supplemental content and the matching object metadata at 224. The exchange server may transmit an instruction, for the AR device, to display the selected AR supplemental content to appear overlaid over the physical environment proximate to the matching object at 226.

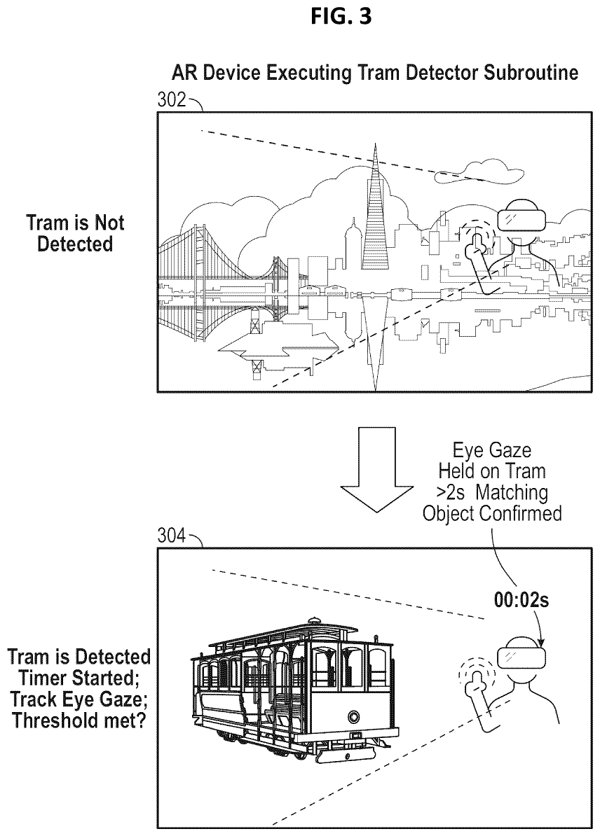

FIG. 3 shows an illustrative scenario 300 of an AR device matching an object in a physical environment, in accordance with some embodiments of this disclosure. The exchange server when transmitting instructions to the AR device to cause the AR device to execute the at least one detector to detect a matching object in a physical environment visible via the AR device, may include further instructions to only detect a matching object if a matching time threshold is met via an eye gaze. For example, if the AR device is gazing at the tram for 0.2 s, this may not be sufficient to indicate a match. However, if the AR device detects an eye gaze for 2.0 s, this may be sufficient to indicate a match. The matching time threshold may be preconfigured to a desired value, or it may be automatically generated based on a mathematical model formed from aggregate data to achieve a more dynamic value. In some embodiments, the exchange server may implement a machine learning model to determine the optimal matching time threshold for a given AR environment. In FIG. 3, the AR device at 302 is viewing the physical environment of San Francisco and has not detected a tram. At 304, the AR device has an eye gaze on the tram for 2 seconds which meets the matching time threshold of greater than 2 seconds and thus constitutes a matching object.

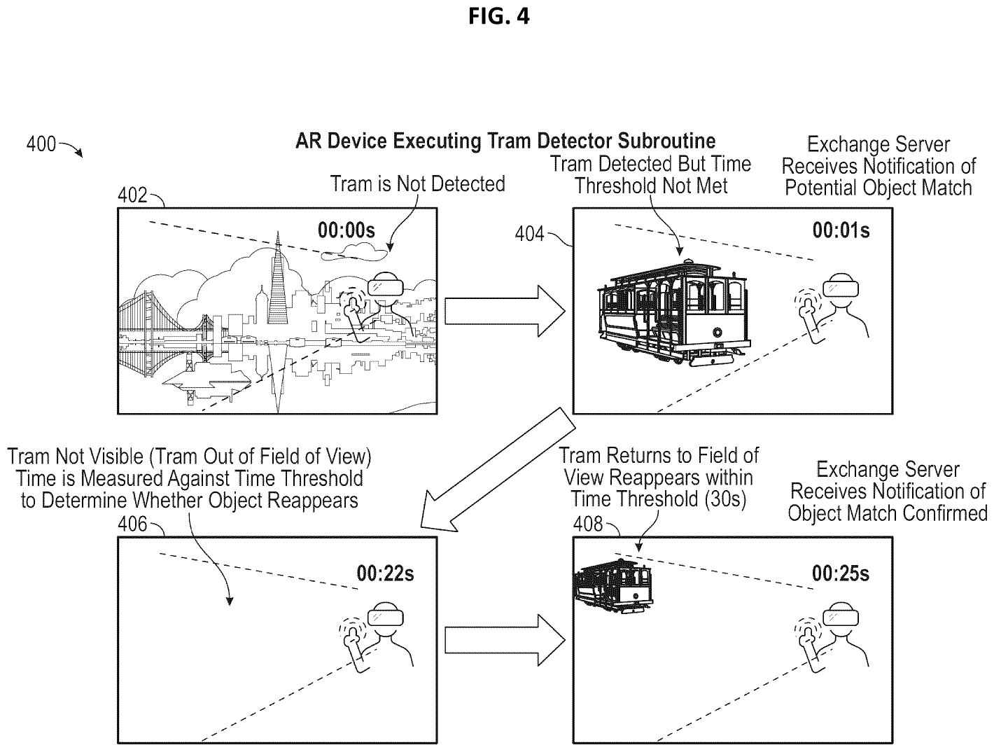

FIG. 4 shows an illustrative scenario 400 of an AR device matching an object in a physical environment where the object comes in and out of view, in accordance with some embodiments of this disclosure. The exchange server when transmitting instructions to the AR device to cause the AR device to execute the at least one detector to detect a matching object in a physical environment visible via the AR device, may include further instructions to only detect a matching object if a matching time threshold is met via an eye gaze-even if the object temporarily is out of the view of the AR device as long as it reappears within a proximity time threshold. The proximity time threshold may be preconfigured to a desired value, or it may be automatically generated based on a mathematical model formed from aggregate data to achieve a more dynamic value. In some embodiments, the exchange server may implement a machine learning model to determine the optimal proximity time threshold for a given AR environment. For example, at 402, the AR device detects no tram. At 404, the AR device detects the tram for one second which does not meet the matching time threshold and thus is not a match. However, there is a proximity time threshold for 30 seconds that initiates upon the first detection to capture a match if the object reappears. At 406, 22 seconds have elapsed and the tram has not returned, but at 408, the tram returns within the proximity time threshold of 30 seconds and moreover the matching time threshold of 2 seconds is met to establish a match.

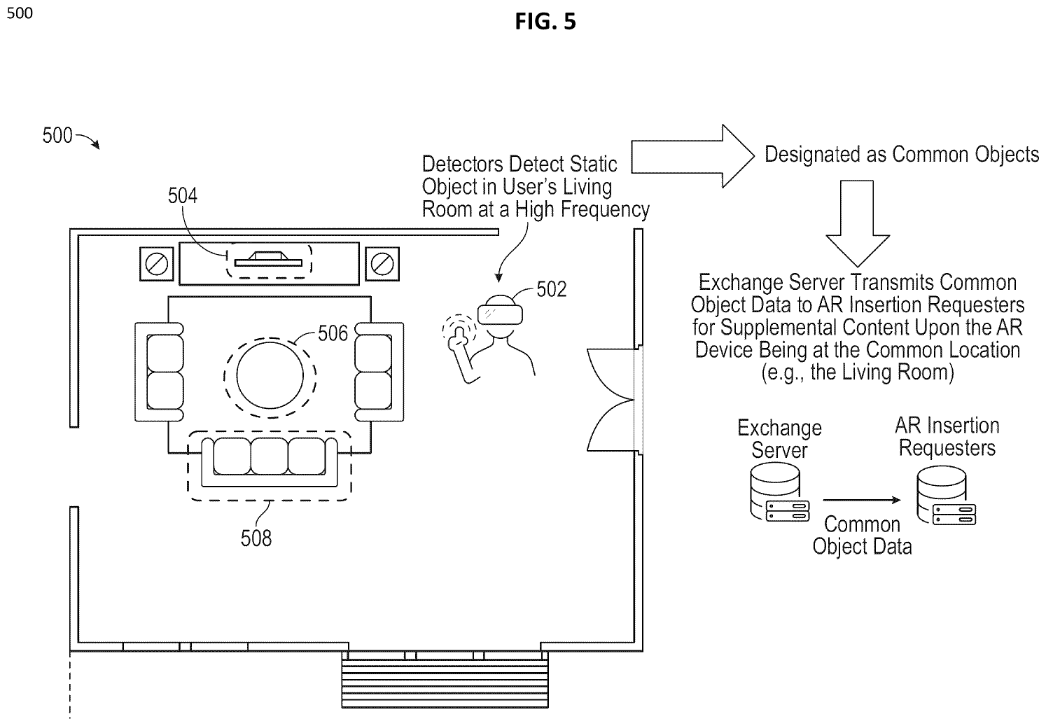

FIG. 5 shows an illustrative scenario 500 of an exchange server saving frequently viewed objects, in accordance with some embodiments of this disclosure. The exchange server may determine whether the indication of detection of the matching object at a corresponding location exceeds a frequency threshold. For example, if the AR device 502 is frequently within a household and some objects have static positions (e.g., a television 504, table 506, and/or couch 508), these objects may be routinely detected at the same corresponding object location. These objects may be designated as common objects. The frequency threshold may be preconfigured to a desired value, or it may be automatically generated based on a mathematical model formed from aggregate data to achieve a more dynamic value. In some embodiments, the exchange server may implement a machine learning model to determine the optimal frequency threshold for a given AR environment (e.g., house). The exchange server in response to a determination that the indication of detection of the matching object at the corresponding location exceeds a frequency threshold, save location data for the matching object. Then, in response to the AR device being within the proximity of the location specified by the location data, the exchange server may select the selected AR supplemental content based on the plurality of requests for AR insertion of AR supplemental content and the matching object metadata and transmit the instruction, for the AR device, to display the selected supplemental content to appear overlaid over the physical environment proximate to the matching object. In this way, the detector selection need not occur at every instance of detecting an object within a known environment if they are designated as common objects. This ultimately reduces the computational load on the exchange server.

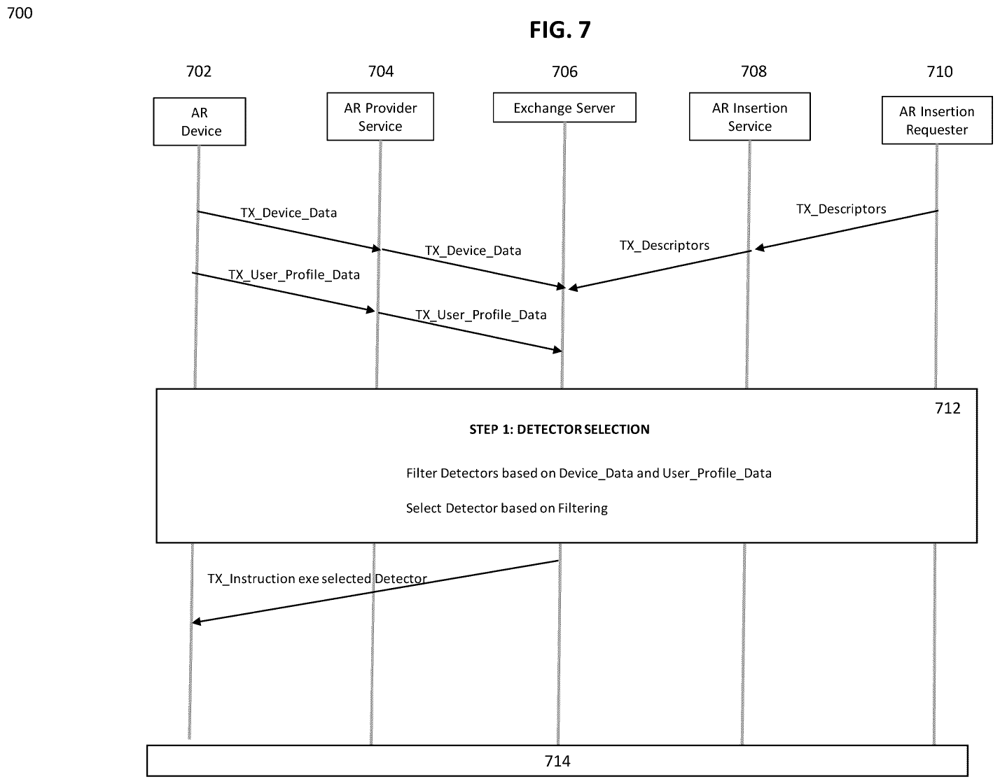

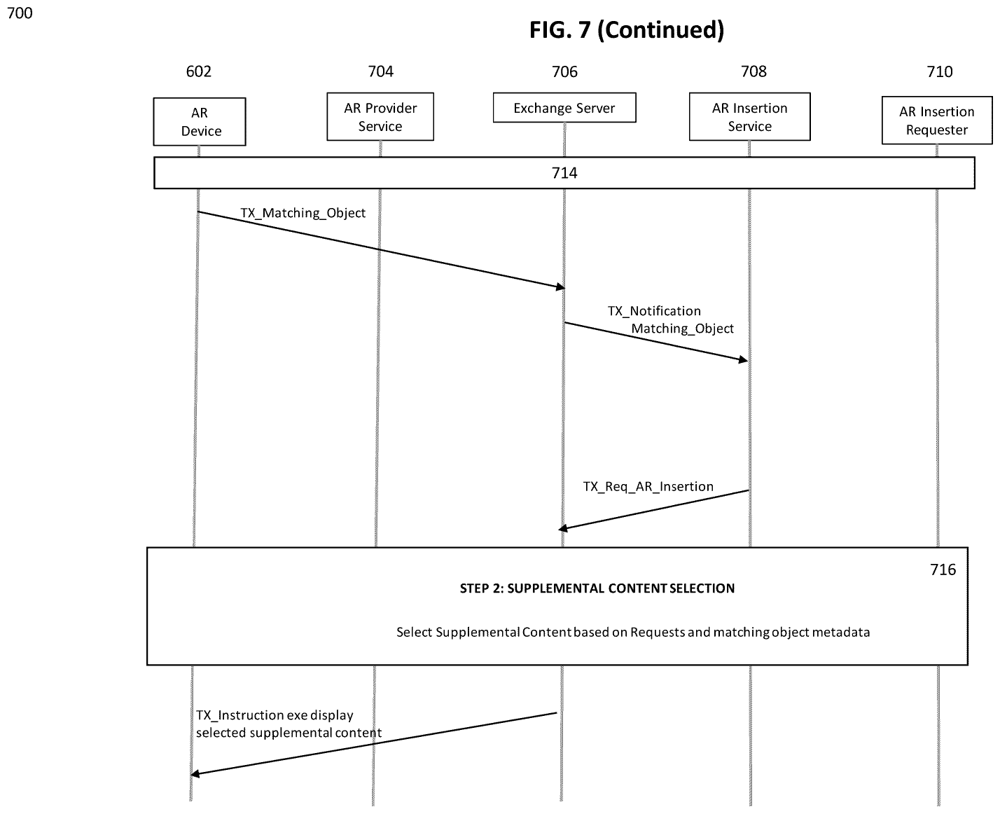

FIG. 7 shows a flowchart 700 of an AR device 702, AR provider service 704, exchange server 706, AR insertion device 708, and AR insertion requester 710, in accordance with some embodiments of this disclosure. This process can be broken down into two main steps as step 1: detector selection (712), and step 2: supplemental content selection (716). In step 1, the exchange server receives transmitted device data from the AR device, either directly, or through the AR provider service. The exchange server further receives transmitted user profile data from the AR device, either directly, or through the AR provider service. The exchange server further receives transmitted descriptors from the AR insertion requester, either directly, or through the AR insertion service. The exchange server then filters the detectors based on the received device data and user profile data, and selects a detector based on this filtering at 712. The process continues though 714. In step 2, the exchange server receives transmitted matching object metadata from the AR device and notifies the AR insertion service of the matching object. The AR insertion service then transmits AR insertion requests to the exchange server. The exchange server selects supplemental content based on the AR insertion requests and the matching object metadata at 716. The exchange server then transmits an instruction to the AR device to display the selected AR supplemental content to appear overlaid over the physical environment proximate to the matching object.

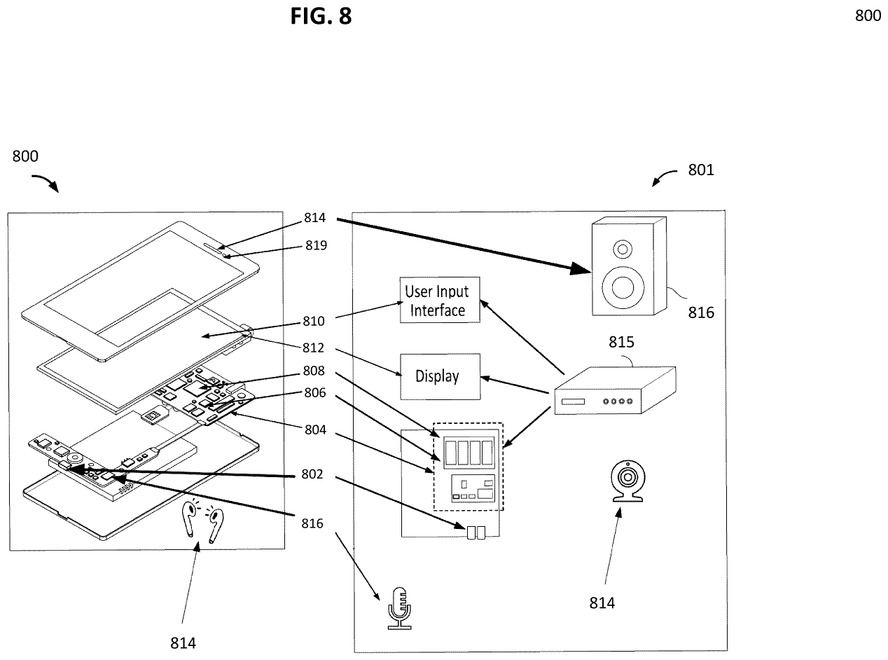

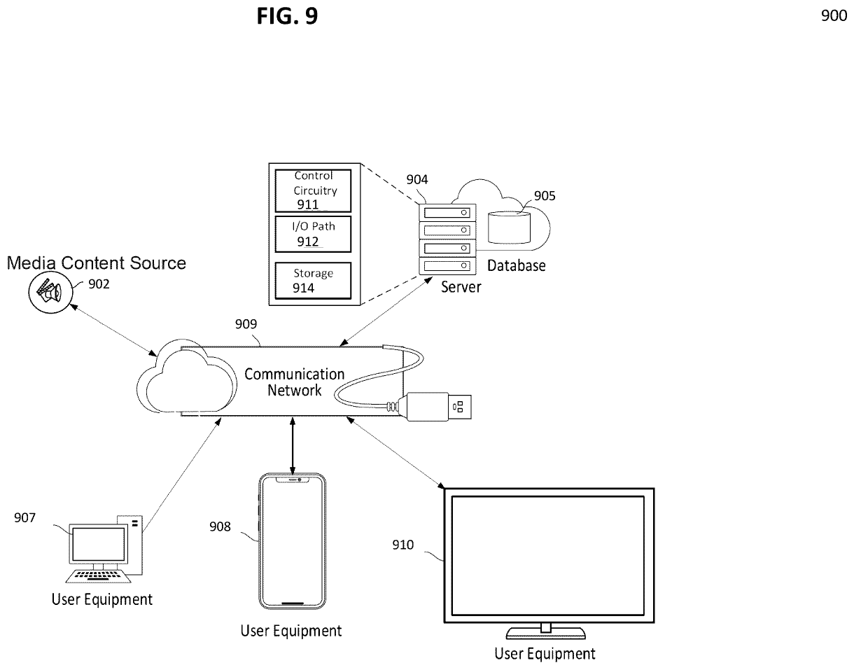

FIGS. 8-9 describe illustrative devices, systems, servers, and related hardware for a media application for efficient navigation of a plurality of media assets and for playing post-credit content in media assets by overriding play-next logic, in accordance with some embodiments of this disclosure. FIG. 8 shows generalized embodiments of illustrative user devices 800 and 801. For example, user equipment device 800 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 801 may be a user television equipment system or device. User television equipment device 801 may include set-top box 815. Set-top box 815 may be communicatively connected to microphone 816, audio output equipment (e.g., speaker or headphones 814), and display 812. In some embodiments, microphone 816 may receive audio corresponding to a voice of a user, e.g., a voice command. In some embodiments, display 812 may be a television display or a computer display. In some embodiments, set-top box 815 may be communicatively connected to user input interface 810. In some embodiments, user input interface 810 may be a remote control device. Set-top box 815 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 8. In some embodiments, device 800 may comprise any suitable number of sensors, as well as a GPS module (e.g., in communication with one or more servers and/or cell towers and/or satellites) to ascertain a location of device 800.

Each one of user equipment device 800 and user equipment device 801 may receive content and data via input/output (I/O) path 802. I/O path 802 may provide content (e.g., broadcast programming, on-demand programming, Internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing. While set-top box 815 is shown in FIG. 8 for illustration, any suitable computing device having processing circuitry, control circuitry, and storage may be used in accordance with the present disclosure. For example, set-top box 815 may be replaced by, or complemented by, a personal computer (e.g., a notebook, a laptop, a desktop), a smartphone (e.g., device 800), a tablet, a network-based server hosting a user-accessible client device, a non-user-owned device, any other suitable device, or any combination thereof.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for the Media application stored in memory (e.g., storage 808). Specifically, control circuitry 804 may be instructed by the Media application to perform the functions discussed above and below. In some implementations, processing or actions performed by control circuitry 804 may be based on instructions received from the Media application.

In client/server-based embodiments, control circuitry 804 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a device 800.

In some embodiments, the media application may be a client/server application where only the client application resides on device 800, and a server application resides on an external server (e.g., server 904 and/or server 916). For example, the media application may be implemented partially as a client application on control circuitry 804 of device 800 and partially on server 904 as a server application running on control circuitry 911. Server 904 may be a part of a local area network with one or more of devices 800 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 904), referred to as “the cloud.” Device 800 may be a cloud client that relies on the cloud computing capabilities from server 904 to determine whether processing should be offloaded and facilitate such offloading. When executed by control circuitry 804 or 911, the media application may instruct control circuitry 804 or 911 circuitry to perform processing tasks for the client device and facilitate a media consumption session integrated with social network services. The client application may instruct control circuitry 804 to determine whether processing should be offloaded.

Control circuitry 804 may include communications circuitry suitable for communicating with a server, social network service, a table or database server, or other networks or servers The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage may be used to supplement storage 808 or instead of storage 808.

Control circuitry 804 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of user equipment 800. Control circuitry 804 may also include digital-to-analog converter circuitry and analog-to-digital converter circuitry for converting between digital and analog signals. The tuning and encoding circuitry may be used by user equipment device 800, 801 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment device 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment device 800 and user equipment device 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 815.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of device 800 and equipment 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 816 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 818 may be any suitable video camera integrated with the equipment or externally connected. Camera 818 may be a digital camera comprising a charge-coupled device (CCD) and/or a complementary metal-oxide semiconductor (CMOS) image sensor. Camera 818 may be an analog camera that converts to digital images via a video card.

The media application may be implemented using any suitable architecture. For example, it may be a stand-alone application wholly-implemented on each one of user equipment device 800 and user equipment device 801. In such an approach, instructions of the application may be stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to provide media consumption and social network interaction functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a media application and social network profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the media application is a client/server-based application. Data for use by a thick or thin client implemented on each one of user equipment device 800 and user equipment device 801 may be retrieved on-demand by issuing requests to a server remote to each one of user equipment device 800 and user equipment device 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on device 800. This way, the processing of the instructions is performed remotely by the server while the resulting displays (e.g., that may include text, a keyboard, or other visuals) are provided locally on device 800. Device 800 may receive inputs from the user via input interface 810 and transmit those inputs to the remote server for processing and generating the corresponding displays. For example, device 800 may transmit a communication to the remote server indicating that an up/down button was selected via input interface 810. The remote server may process instructions in accordance with that input and generate a display of the application corresponding to the input (e.g., a display that moves a cursor up/down). The generated display may then be transmitted to device 800 for presentation to the user.

In some embodiments, the media application may be downloaded and interpreted or otherwise run by an interpreter or virtual machine (run by control circuitry 804). In some embodiments, the media application may be encoded in the ETV Binary Interchange Format (EBIF), received by control circuitry 804 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804. In some of such embodiments (e.g., those employing MPEG-2 or other digital media encoding schemes), the media application may be, for example, encoded and transmitted in an MPEG-2 object carousel with the MPEG audio and video packets of a program.

FIG. 9 is a diagram of an illustrative system 900, in accordance with some embodiments of this disclosure. User equipment devices 907, 908, 910 (e.g., user device; devices or any other suitable devices, or any combination thereof) may be coupled to communication network 906. Communication network 906 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 906.

System 900 may comprise media content source 902, one or more servers 904, and one or more social network services. In some embodiments, the media application may be executed at one or more of control circuitry 911 of server 904 (and/or control circuitry of user equipment devices 907, 908, 910.

In some embodiments, server 904 may include control circuitry 911 and storage 914 (e.g., RAM, ROM, Hard Disk, Removable Disk, etc.). Instructions for the media application may be stored in storage 914. In some embodiments, the media application, via control circuitry, may execute functions outlined in FIGS. 1-11. Storage 914 may store one or more databases. Server 904 may also include an input/output path 912. I/O path 912 may provide media consumption data, social networking data, device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 (and specifically control circuitry) to one or more communications paths. I/O path 912 may comprise I/O circuitry.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 911 executes instructions for an emulation system application stored in memory (e.g., the storage 914). Memory may be an electronic storage device provided as storage 914 that is part of control circuitry 911.

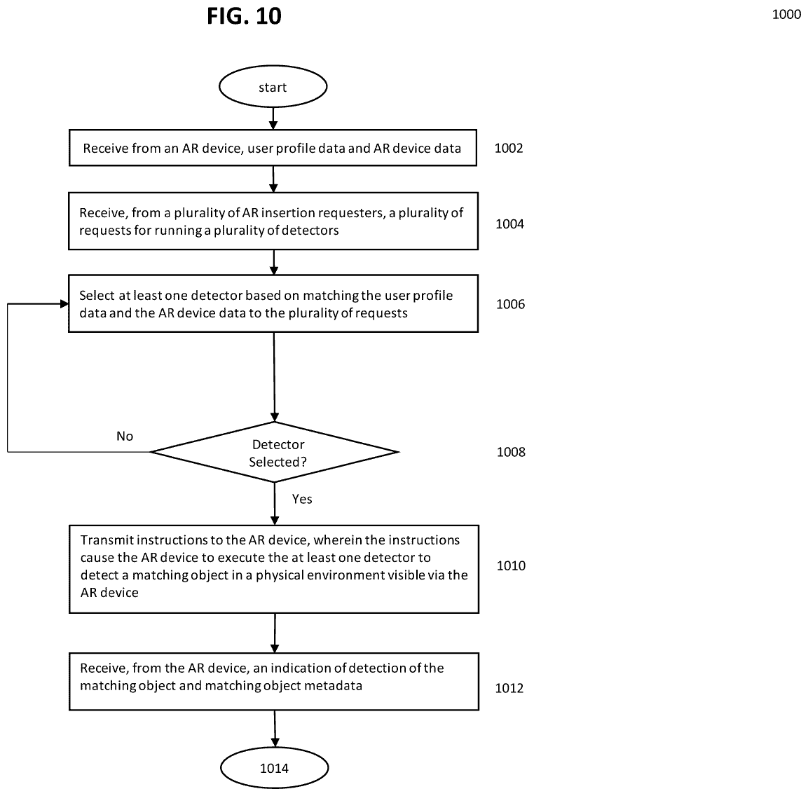

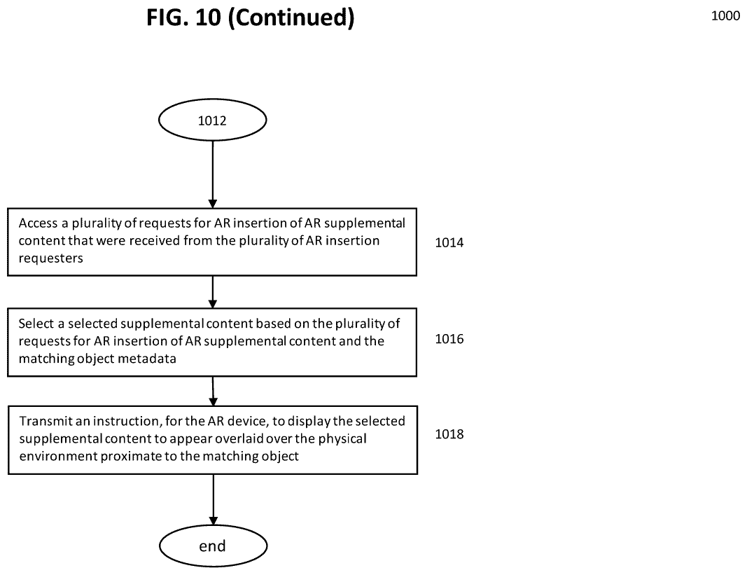

FIG. 10 is a flowchart of a detailed illustrative process 1000 for transmitting an instruction to display the selected supplemental content to appear overlaid over the physical environment proximate to the matching object, in accordance with some embodiments of this disclosure. In various embodiments, the individual steps of process 1000 may be implemented by one or more components of the devices and systems of FIGS. 1-9. Although the present disclosure may describe certain steps of process 1000 (and of other processes described herein) as being implemented by certain components of the devices and systems of FIGS. 1-9, this is for purposes of illustration only, and it should be understood that other components of the devices and systems of FIGS. 1-9 may implement those steps instead.

At 1002, the exchange server, via the control circuitry 911, receives from an AR device, user profile data and AR device data. In some embodiments, the user profile data and AR device data is received via the I/O path 912 via the communication network 909. In some embodiments, the user profile data is stored in storage 914. At 1004, the exchange server, via control circuitry 911, receives, from a plurality of AR insertion requesters, a plurality of requests for running a plurality of detectors. In some embodiments, the plurality of requests is received via the I/O path 912 via the communication network 909. In some embodiments, the AR insertion requester has similar circuitry to the exchange server having independent control circuitry, storage, I/O path and interfacing a communication path. At 1006, the exchange server, via control circuitry 911, selects at least one detector based on matching the user profile data and the AR device data to the plurality of requests. If at 1008, the exchange server, via control circuitry 911, selects a detector, then processing proceeds to 1010. If at 1008, the exchange server, via control circuitry 911, does not select a detector, then processing reverts to 1006. At 1010, the exchange server, via control circuitry 911, transmits instructions to the AR device where the instructions cause the AR device to execute the at least one detector to detect a matching object in a physical environment visible via the AR device. In some embodiments, the AR device has similar circuitry to the exchange server having independent control circuitry, storage, I/O path and interfacing a communication path. In some embodiments, the transmission is implemented via the I/O path 912 and/or the communication network 909. At 1012, the exchange server, via control circuitry 911, receives, from the AR device, an indication of detection of the matching object and matching object metadata. In some embodiments, the reception of the indication of detection is via the I/O path 912 and/or the communication network 909. At 1014, the exchange server, via control circuitry 911, accesses a plurality of requests for AR insertion of AR supplemental content that were received from the plurality of AR insertion requesters. At 1016, the exchange server, via control circuitry 911, selects a selected supplemental content based on the plurality of requests for AR insertion of AR supplemental content and the matching object metadata. At 1018, the exchange server, via control circuitry 911, transmits an instruction, for the AR device, to display the selected supplemental content to appear overlaid over the physical environment proximate to the matching object. In some embodiments, the transmission of the instruction is via the I/O path 912 and/or the communication network 909.

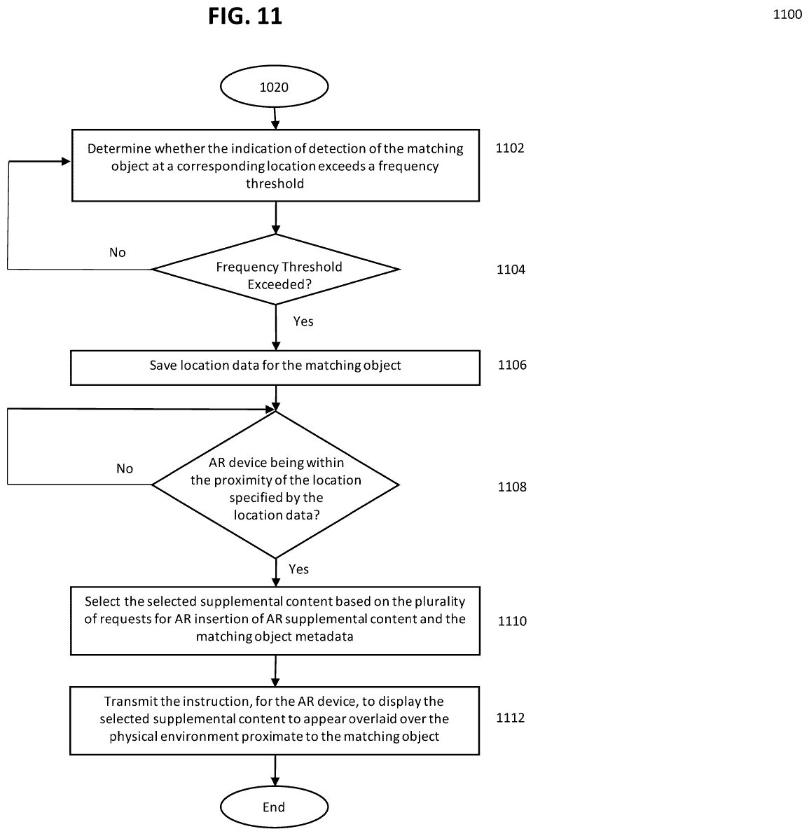

FIG. 11 is a flowchart of another detailed illustrative process 1100 for determining whether the indication of detection of the matching object at a corresponding location exceeds a frequency threshold, in accordance with some embodiments of this disclosure. At 1102, the exchange server, via the control circuitry 911, determines whether the indication of detection of the matching object at a corresponding location exceeds a frequency threshold. If at 1104, the exchange server, via control circuitry 911, determines the indication of detection of the matching object at a corresponding location does not exceed the frequency threshold, then processing reverts to 1102. If at 1104, the exchange server, via control circuitry 911, determines the indication of detection of the matching object at a corresponding location exceeds the frequency threshold, then processing proceeds to 1106. At 1106, the exchange server, via the control circuitry 911, saves location data for the matching object. In some embodiments, the location data is saved in at least one of database 905, storage 914, or media content source 902. At 1108, the exchange server, via the control circuitry 911, determines whether the AR device is within the proximity of the location specified by the location data. If at 1108, the exchange server, via control circuitry 911, determines the AR device is not within the proximity of the location specified by the location data, then processing reverts to 1106. If at 1108, the exchange server, via control circuitry 911, determines the AR device is within the proximity of the location specified by the location data, then processing continues to 1110. At 1110, the exchange server, via the control circuitry 911, selects the selected supplemental content based on the plurality of requests for AR insertion of AR supplemental content and the matching object metadata. At 1112, transmits an instruction, for the AR device, to display the selected supplemental content to appear overlaid over the physical environment proximate to the matching object. In some embodiments, the transmission of the instruction is via the I/O path 912 and/or the communication network 909. In some embodiments, the AR device has similar circuitry to the exchange server having independent control circuitry, storage, I/O path and interfacing a communication path.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from an Augmented Reality (AR) device, user profile data and AR device data;
receiving, from a plurality of AR insertion requesters, a plurality of requests for running a plurality of detectors;
selecting at least one detector based on matching the user profile data and the AR device data to the plurality of requests;
transmitting instructions to the AR device, wherein the instructions cause the AR device to execute the at least one detector to detect a matching object in a physical environment visible via the AR device;
receiving, from the AR device, an indication of detection of the matching object and matching object metadata;
accessing a plurality of requests for AR insertion of AR supplemental content that were received from the plurality of AR insertion requesters;
selecting a selected AR supplemental content based on the plurality of requests for AR insertion of AR supplemental content and the matching object metadata; and
transmitting an instruction, for the AR device, to display the selected AR supplemental content to appear overlaid over the physical environment proximate to the matching object.

2. The method of claim 1, wherein the accessing the plurality of requests for AR insertion of AR supplemental content that were received from the plurality of AR insertion requesters comprises:
transmitting a detection notification to the plurality of AR insertion requesters; and
receiving a plurality of requests for AR insertion of AR supplemental content from the plurality of AR insertion requesters.

3. The method of claim 1, further comprising:
determining whether the indication of detection of the matching object at a corresponding location exceeds a frequency threshold;
in response to a determination that the indication of detection of the matching object at the corresponding location exceeds a frequency threshold, saving location data for the matching object; and
in response to the AR device being within proximity of a location specified by the location data:
selecting the selected AR supplemental content based on the plurality of requests for AR insertion of AR supplemental content and the matching object metadata; and
transmitting the instruction, for the AR device, to display the selected supplemental content to appear overlaid over the physical environment proximate to the matching object.

4. The method of claim 1, wherein the receiving, from the AR device, the indication of detection of the matching object and matching object metadata is based at least in part on an activity of a user of the AR device based on at least one of a movement pattern or biometric data.

5. The method of claim 1, wherein the executing the at least one detector to detect the matching object in the physical environment further comprises:
receiving training data with confirmed data of the matching object;
training a machine learning model based on the received training data;
detecting a visual representation of the matching object; and
inserting the visual representation of the matching object into the trained model.

6. The method of claim 1, wherein the selecting of at least one detector based on matching the user profile data and the AR device data to the plurality of requests further comprises:
determining, for a particular detector, the number of AR insertion requesters requesting the particular detector; and
in response to the number of AR insertion requesters exceeding a popularity threshold, selecting the particular detector.

7. The method of claim 1, wherein matching object metadata comprises at least one of matching object lighting, matching object coordinates, or matching object obstruction level.

8. The method of claim 1, wherein the receiving, from the Augmented Reality (AR) device, the user profile data and the AR device data comprises receiving the user profile data and the AR device data via an AR provider service.

9. The method of claim 1, wherein the receiving the plurality of requests for AR insertion of AR supplemental content from the plurality of AR insertion requesters comprises receiving the plurality of requests for AR insertion via an AR insertion service.

10. The method of claim 1, wherein the AR device data comprises at least one of processing capacity, LIDAR, biometric information, optical device capacity, or networking capacity.

11. A system comprising:
control circuitry configured to:
receive, from an Augmented Reality (AR) device, user profile data and AR device data;
receive, from a plurality of AR insertion requesters, a plurality of requests for running a plurality of detectors;
select at least one detector based on matching the user profile data and the AR device data to the plurality of requests;
transmit instructions to the AR device, wherein the instructions cause the AR device to execute the at least one detector to detect a matching object in a physical environment visible via the AR device;
receive, from the AR device, an indication of detection of the matching object and matching object metadata;
access a plurality of requests for AR insertion of AR supplemental content that were received from the plurality of AR insertion requesters;
select a selected AR supplemental content based on the plurality of requests for AR insertion of AR supplemental content and the matching object metadata; and
transmit an instruction, for the AR device, to display the selected AR supplemental content to appear overlaid over the physical environment proximate to the matching object.

12. The system of claim 11, wherein the system is configured, when accessing the plurality of requests for AR insertion of AR supplemental content that were received from the plurality of AR insertion requesters, to:
transmit a detection notification to the plurality of AR insertion requesters; and
receive a plurality of requests for AR insertion of AR supplemental content from the plurality of AR insertion requesters.

13. The system of claim 11, wherein the system is further configured to:
determine whether the indication of detection of the matching object at a corresponding location exceeds a frequency threshold;
in response to a determination that the indication of detection of the matching object at the corresponding location exceeds a frequency threshold, save location data for the matching object; and
in response to the AR device being within proximity of a location specified by the location data:
select the selected AR supplemental content based on the plurality of requests for AR insertion of AR supplemental content and the matching object metadata; and
transmit the instruction, for the AR device, to display the selected supplemental content to appear overlaid over the physical environment proximate to the matching object.

14. The system of claim 11, wherein the system is configured when receiving, from the AR device, the indication of detection of the matching object and matching object metadata to base at least in part on an activity of a user of the AR device based on at least one of a movement pattern or biometric data.

15. The system of claim 11, wherein the system is further configured, when executing the at least one detector to detect the matching object in the physical environment, to:
receive training data with confirmed data of the matching object;
train a machine learning model based on the received training data;
detect a visual representation of the matching object; and
insert the visual representation of the matching object into the trained model.

16. The system of claim 11, wherein the system is configured, when selecting the at least one detector based on matching the user profile data and the AR device data to the plurality of requests further, to:
determine, for a particular detector, the number of AR insertion requesters requesting the particular detector; and
in response to the number of AR insertion requesters exceeding a popularity threshold, selecting the particular detector.

17. The system of claim 11, wherein matching object metadata comprises at least one of matching object lighting, matching object coordinates, or matching object obstruction level.

18. The system of claim 11, wherein the receiving, from the Augmented Reality (AR) device, the user profile data and the AR device data comprises receiving the user profile data and the AR device data via an AR provider service.

19. The system of claim 11, wherein the receiving the plurality of requests for AR insertion of AR supplemental content from the plurality of AR insertion requesters comprises receiving the plurality of requests for AR insertion via an AR insertion service.

20. (canceled)

21. A system comprising:
means for receiving, from an Augmented Reality (AR) device, user profile data and AR device data;
means for receiving, from a plurality of AR insertion requesters, a plurality of requests for running a plurality of detectors;
means for selecting at least one detector based on matching the user profile data and the AR device data to the plurality of requests;
means for transmitting instructions to the AR device, wherein the instructions cause the AR device to execute the at least one detector to detect a matching object in a physical environment visible via the AR device;
means for receiving, from the AR device, an indication of detection of the matching object and matching object metadata; means for accessing a plurality of requests for AR insertion of AR supplemental content that were received from the plurality of AR insertion requesters;
means for selecting a selected AR supplemental content based on the plurality of requests for AR insertion of AR supplemental content and the matching object metadata; and
means for transmitting an instruction, for the AR device, to display the selected AR supplemental content to appear overlaid over the physical environment proximate to the matching object.

22.-50. (canceled)
